(19) United States
(12) Patent Application Publication
(10) Pub. No.: US 2023/0129419 A1
(43) Pub. Date: Apr. 27, 2023

(54) METHOD AND APPARATUS FOR IMPROVING POSITIONING OF VEHICLES BASED ON INFRASTRUCTURE SENSING INFORMATION

(71) Applicant: Industry-Academic Cooperation Foundation, KOREA NATIONAL UNIVERSITY OF TRANSPORTATION, Chungju-si (KR)

(72) Inventor: Manbok PARK, Seoul (KR)

(73) Assignee: Industry-Academic Cooperation Foundation, KOREA NATIONAL UNIVERSITY OF TRANSPORTATION, Chungju-si (KR)

(21) Appl. No.: 17/508,399

(22) Filed: Oct. 22, 2021

(30) Foreign Application Priority Data
Oct. 21, 2021 (KR) 10-2021-0141055

(51) Int. Cl. G01S 19/40; G01S 17/89

(52) U.S. Cl. CPC G01S 19/40; G01S 17/89

(57) ABSTRACT

Disclosed are a method and an apparatus for improving positioning of vehicles based on infrastructure sensing information. The method for improving positioning of vehicles based on infrastructure sensing information may include steps of (a) receiving an absolute position of a peripheral vehicle located within a certain distance to a vehicle from an infrastructure device; (b) determining a first relative distance of the peripheral vehicle through an environmental sensor of the vehicle; and (c) performing positioning correction for the absolute position of the vehicle based on an absolute position of the peripheral vehicle and a first relative distance of the peripheral vehicle.

### CROSS-REFERENCE TO RELATED APPLICATIONS

This application claims the priority of Korean Patent Application No. 10-2021-0141055 filed on Oct. 21, 2021 in the Korean Intellectual Property Office, the disclosure of which is incorporated herein by reference.

### BACKGROUND OF THE INVENTION

### Field of the Invention

The present disclosure relates to a method and an apparatus for improving positioning of vehicles based on infrastructure sensing information, and more particularly, to a method and an apparatus for improving positioning of vehicles based on infrastructure sensing information which is received from an infrastructure device.

### Description of the Related Art

In the field of mart vehicles or autonomous driving vehicles, a technique for accurately identifying (positioning) the position of a subject vehicle is required.

GNSS is utilized as the most widely used positioning system. The global navigation satellite system (GNSS) is collectively referred to as a system for providing information about a position, a height, and a speed of an object on the ground using a satellite, and a global positioning system (GPS) in US is representative.

In the case of a widely used low-cost GPS, it is sufficient to determine the direction or position of a vehicle, and whether the vehicle is currently located on any road. However, in the case of the low-cost GPS, an error of about 2 meters occurs, and a large error of 7 meters or more occurs when a signal reception environment is not good, such as a downtown area with many buildings and a mountain area. Therefore, there is a difficulty that the low-cost GPS is used in an autonomous driving environment that needs to be classified up to a driving lane.

To this end, after an expensive GPS module with high position accuracy is mounted, a technology of autonomous driving vehicles may be demonstrated, but since the price of the expensive GPS is equivalent to 30 million won to 100 million won, there is a problem that it is difficult to be commercialized.

The above-described technical configuration is the background art for helping in the understanding of the present invention, and does not mean a conventional technology widely known in the art to which the present invention pertains.

### SUMMARY OF THE INVENTION

The present disclosure is created to solve the above-mentioned problems and an object of the present disclosure is to provide a method and an apparatus for improving positioning of vehicles based on infrastructure sensing information.

Another object of the present disclosure is to provide a method and an apparatus for improving positioning of vehicles based on the absolute position of the peripheral vehicle received from the infrastructure device.

Another object of the present disclosure is to provide a method and an apparatus for performing positioning correction based on infrastructure sensing information received from an infrastructure device and a relative distance of a peripheral vehicle calculated through an environmental sensor mounted on the vehicle.

Objects of the present disclosure are not limited to the objects described above, and other objects, which are not mentioned above, will be apparent from the following description.

According to an embodiment of the present disclosure, a method for improving positioning of vehicles based on infrastructure sensing information may include the steps of (a) receiving an absolute position of a peripheral vehicle located within a certain distance to a vehicle from an infrastructure device; (b) determining a first relative distance of the peripheral vehicle through an environmental sensor of the vehicle; and (c) performing positioning correction for the absolute position of the vehicle based on an absolute position of the peripheral vehicle and a first relative distance of the peripheral vehicle.

In the embodiment, the absolute position of the peripheral vehicle may be determined from an absolute position of the infrastructure device and a second relative distance of the peripheral vehicle calculated by the infrastructure device.

In the embodiment, step (c) may include steps of converting the absolute position of the peripheral vehicle to the second relative distance of the peripheral vehicle based on the absolute position of the vehicle; and performing positioning correction of the absolute position of the vehicle based on the first relative distance of the peripheral vehicle and the second relative distance of the peripheral vehicle.

In the embodiment, step (c) may include steps of calculating a relative positioning correction amount for the vehicle based on the first relative distance of the peripheral vehicle and the second relative distance of the peripheral vehicle; and converting the relative positioning correction amount for the vehicle to an absolute positioning correction amount for the vehicle.

In the embodiment, step (c) may include a step of correcting the absolute position of the vehicle using the absolute positioning correction amount for the vehicle.

According to another embodiment of the present disclosure, an apparatus for improving positioning of vehicles based on infrastructure sensing information may include a communication unit for receiving an absolute position of a peripheral vehicle located within a certain distance to a vehicle from an infrastructure device; and a control unit for determining a first relative distance of the peripheral vehicle through an environmental sensor of the vehicle and performing positioning correction for the absolute position of the vehicle based on an absolute position of the peripheral vehicle and a first relative distance of the peripheral vehicle.

In the embodiment, the absolute position of the peripheral vehicle may be determined from an absolute position of the infrastructure device and a second relative distance of the peripheral vehicle calculated by the infrastructure device.

In the embodiment, the control unit may convert the absolute position of the peripheral vehicle to the second relative distance of the peripheral vehicle based on the absolute position of the vehicle, and perform positioning correction of the absolute position of the vehicle based on the first relative distance of the peripheral vehicle and the second relative distance of the peripheral vehicle.

In the embodiment, the control unit may calculate a relative positioning correction amount for the vehicle based on the first relative distance of the peripheral vehicle and the second relative distance of the peripheral vehicle and convert the relative positioning correction amount for the vehicle to an absolute positioning correction amount for the vehicle.

In the embodiment, the control unit may correct the absolute position of the vehicle using the absolute positioning correction amount for the vehicle.

Specific matters for achieving the above objects will be apparent with reference to embodiments to be described below in detail together with the accompanying drawings.

However, the present disclosure is not limited to embodiments to be disclosed below, but may be configured in various different forms, and will be provided to make the disclosure of the present disclosure complete and fully notify the scope of the present disclosure to persons with ordinary skill in the art to which the inventions pertain (hereinafter, “those skilled in the art”).

According to an embodiment of the present disclosure, even though a low-cost GPS module is mounted, it is possible to confirm an error of a GPS coordinate using a Lidar and infrastructure sensing information and to secure accurate position data by correcting the GPS coordinate information by the confirmed error. Therefore, it is possible to advance the commercialization of the autonomous vehicle by improving the position accuracy at a low price in an autonomous driving vehicle field.

The effects of the present disclosure are not limited to the above-described effects, and it will be understood that provisional effects toe expected by technical features of the present disclosure will be apparent from the following description.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a diagram illustrating a system for improving positioning of vehicles based on infrastructure sensing information according to an embodiment of the present disclosure;

FIG. 2 is a diagram illustrating a method for improving positioning of vehicles based on infrastructure sensing information according to an embodiment of the present disclosure;

FIGS. 3A to 3C are diagrams illustrating examples for calculating center points of peripheral vehicles and extracting an object size according to an embodiment of the present disclosure;

FIGS. 4A to 4C are diagrams illustrating examples for improving positioning of vehicles based on infrastructure sensing information according to an embodiment of the present disclosure; and

FIG. 5 is a diagram illustrating a functional configuration of an apparatus for improving positioning of vehicles based on infrastructure sensing information according to an embodiment of the present disclosure.

### DETAILED DESCRIPTION OF THE PREFERRED EMBODIMENT

The present disclosure may have various modifications and various embodiments and specific embodiments will be illustrated in the drawings and described in detail.

Various features of the invention disclosed in the appended claims will be better understood in consideration of the drawings and the detailed description. Apparatuses, methods, manufacturing methods and various embodiments disclosed in the specification will be provided for illustrative purposes. The disclosed structural and functional features are intended to allow those skilled in the art to be specifically implemented in various embodiments, but are not intended to limit the scope of the invention. The disclosed terms and sentences are intended to be easily explained to the various features of the disclosed invention, but are not intended to limit the scope of the invention.

In describing the present disclosure, the detailed description of related known technologies will be omitted if it is determined that they unnecessarily make the gist of the present disclosure unclear.

Hereinafter, a method and an apparatus for improving positioning of vehicles based on infrastructure sensing information according to an embodiment of the present disclosure will be described.

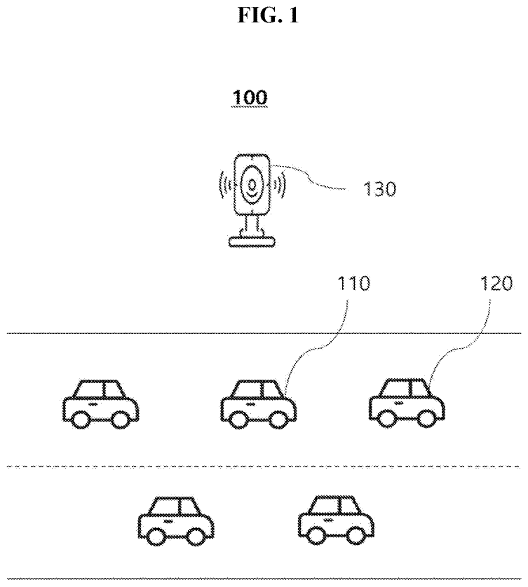

FIG. 1 is a diagram illustrating a system 100 for improving positioning of vehicles based on infrastructure sensing information according to an embodiment of the present disclosure.

Referring to FIG. 1, the system 100 for improving the positioning may include a vehicle 110, at least one peripheral vehicle 120, and an infrastructure device 130.

The vehicle 110 may include an environmental sensor, and may determine a first relative distance from the peripheral vehicle 120 using the environmental sensor. Here, the first relative distance may include a distance between the vehicle 110 and the peripheral vehicle 120 measured through the environmental sensor of the vehicle 110.

The infrastructure device 130 includes an environmental sensor, and may detect the peripheral vehicle 120 located within a certain distance from the vehicle 110 using the environmental sensor and determine a second relative distance from the peripheral vehicle 120.

In an embodiment, the infrastructure device 130 may acquire information about the exterior of the peripheral vehicle 120 through the environment sensor of the infrastructure device 130 to detect the relative position and size information of the peripheral vehicle 120.

In an embodiment, the infrastructure device 130 may determine a second relative distance to indicate a relative distance from the environmental sensor mounted on the infrastructure device 130 to the peripheral vehicle 120 using the relative position and size information of the peripheral vehicle 120.

In an embodiment, the infrastructure device 130 may determine the absolute position of the peripheral vehicle 120 from the second relative distance of the peripheral vehicle 120 based on the absolute position of the infrastructure device 130.

In an embodiment, the infrastructure device 130 may transmit at least one of size information and an absolute position of the peripheral vehicle 120 to the vehicle 110.

In one embodiment, the infrastructure device 130 may recognize the peripheral vehicle 120 based on an object bounding box using a camera sensor. In addition, the infrastructure device 130 may calculate a center point of the peripheral vehicle 120 based on point cloud data using a Lidar sensor.

Here, the second relative distance may include a distance between the infrastructure device 130 and the peripheral vehicle 120 measured using the environmental sensor of the infrastructure device 130.

The infrastructure device 130 may convert the second relative distance from the peripheral vehicle 120 to an absolute position of the peripheral vehicle 120 based on an absolute position of the infrastructure device 130, and transmit the absolute position of the peripheral vehicle 120 to the vehicle 110.

Since the infrastructure device 130 is fixed to a specific position on the roadside, the infrastructure device 130 may accurately confirm the absolute position of the infrastructure device 130, and since the accurate absolute position of the infrastructure device 130 is used as a reference, the absolute position of the peripheral vehicle 120 may be more accurately calculated.

In one embodiment, since the infrastructure device 130 is fixed to a specific position on the roadside, the infrastructure device 130 may pre-store the absolute position of the infrastructure device 130.

The vehicle 110 may perform positioning correction for the absolute position of the vehicle 110 using the absolute position of the peripheral vehicle 120 and the first relative distance of the peripheral vehicle 120.

In various embodiments of the present disclosure, the environmental sensor may be used for recognizing an object by scanning or photographing surrounding objects and acquiring and processing data. For example, an environmental sensor may include a laser scanner, a Radar, a Lidar, a camera, and the like, and in the embodiment, an example of using the Lidar as the environmental sensor will be illustrated and described.

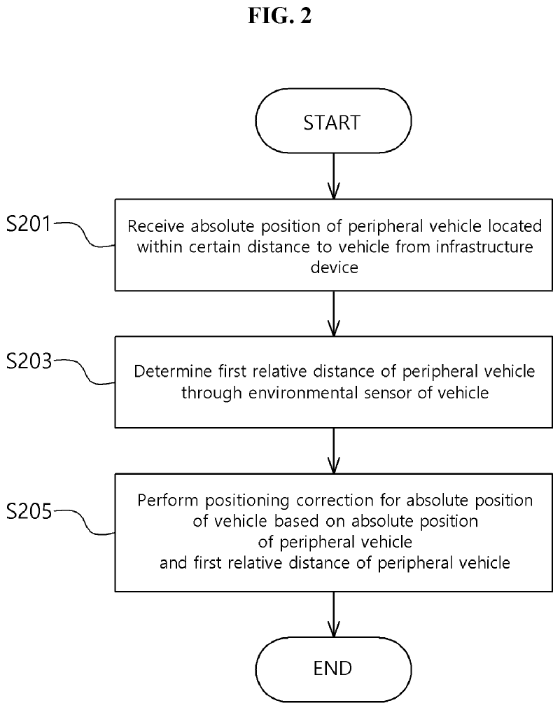

FIG. 2 is a diagram illustrating a method for improving positioning of vehicles based on infrastructure sensing information according to an embodiment of the present disclosure.

Referring to FIG. 2, step S201 is a step of receiving an absolute position of a peripheral vehicle 120 located within a certain distance to a vehicle 110 from an infrastructure device 130.

In one embodiment, the absolute position of the peripheral vehicle 120 may be determined from an absolute position of the infrastructure device 130 and a second relative distance of the peripheral vehicle 120 calculated by the infrastructure device 130.

Step S203 is a step of determining a first relative distance of the peripheral vehicle 120 through an environmental sensor of the vehicle 110.

Step S205 is a step of performing positioning correction for the absolute position of the vehicle 110 based on the absolute position of the peripheral vehicle 120 and the first relative distance of the peripheral vehicle 120.

In one embodiment, based on the absolute position of the vehicle 110, the absolute position of the peripheral vehicle 120 is converted to the second relative distance of the peripheral vehicle 120, and based on the first relative distance of the peripheral vehicle 120 and the second relative distance of the peripheral vehicle 120, the positioning correction of the absolute position of the vehicle 110 may be performed.

In one embodiment, based on the first relative distance of the peripheral vehicle 120 and the second relative distance of the peripheral vehicle 120, a relative positioning correction amount for the vehicle is calculated and the relative positioning correction amount for the vehicle 110 may be converted to an absolute positioning correction amount for the vehicle 110.

In one embodiment, the absolute position of the vehicle 110 may be corrected using an absolute positioning correction amount for the vehicle 110.

In an embodiment, the first absolute position of the vehicle 110 as well as the peripheral vehicle 120 may be received from the infrastructure device 130. At this time, if an error between the second absolute position of the vehicle 110 calculated based on the GPS module mounted on the vehicle 110 and the first absolute position of the vehicle 110 calculated by the infrastructure device 130 is larger than a threshold value, correcting the second absolute position using the absolute positioning correction amount, and re-calibrating the corrected second absolute position based on the first absolute position of the vehicle 110, the positioning correction accuracy can be further improved have.

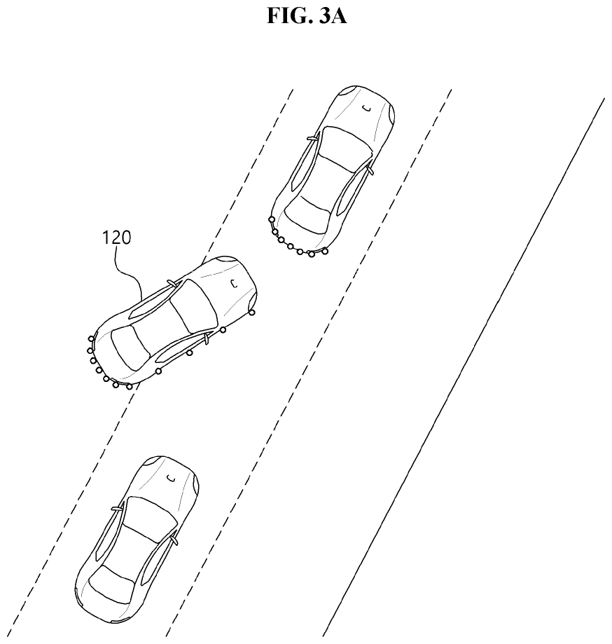

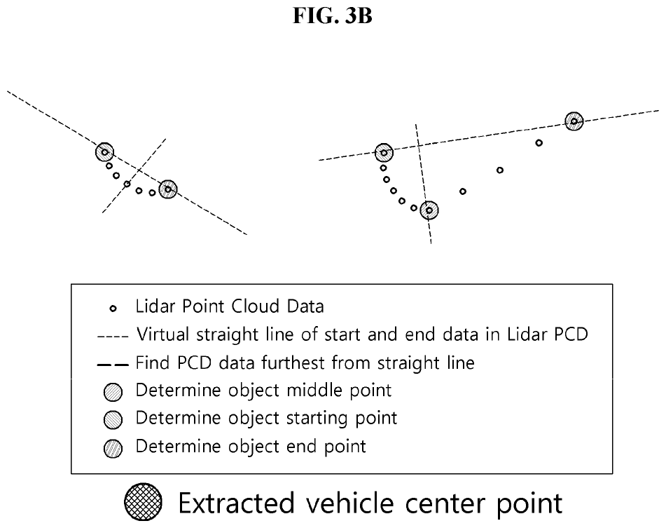

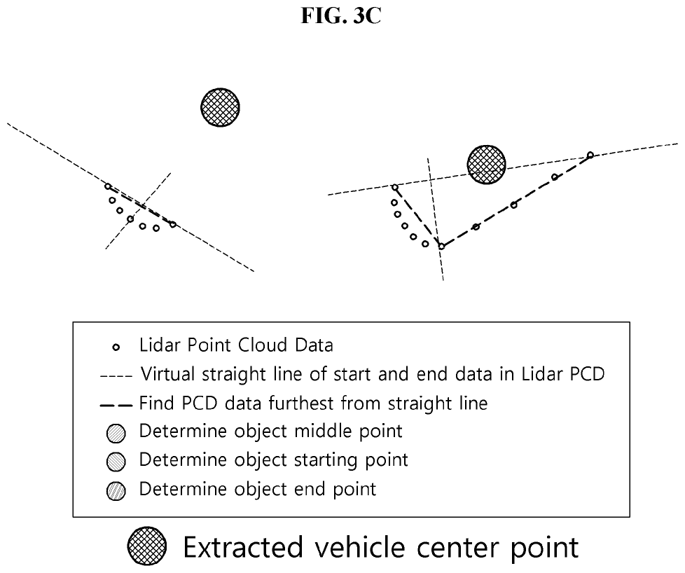

FIGS. 3A to 3C are diagrams illustrating examples for calculating center points of the peripheral vehicle 120 and extracting an object size according to an embodiment of the present disclosure.

Referring to FIGS. 3A to 3C, the calculation of the center points of the peripheral vehicle 120 may be performed to calculate the first relative distance of the peripheral vehicle 120 by the vehicle 110 through the environmental sensor or performed to calculate the second relative distance of the peripheral vehicle 120 by the infrastructure device 130 through the environmental sensor. However, for convenience of description, it will be described that the calculation of the center points of the peripheral vehicle 120 is performed by the vehicle 110. In the embodiment, an example of using a Lidar as an environmental sensor will be illustrated and described.

The vehicle 110 may acquire a plurality of point cloud data for an external boundary of the peripheral vehicle 120.

The vehicle 110 may determine the center point of the peripheral vehicle from a virtual straight line of the plurality of point cloud data. For example, the vehicle 110 generates a virtual straight line that connects a starting point and an end point of the plurality of point cloud data, and may determine a middle point of the point cloud data located farthest from the virtual straight line of the plurality of point cloud data.

Thereafter, the vehicle 110 may determine the center point of the peripheral vehicle 120 based on the starting point, the middle point, and the end point of the point cloud data, and determine a first relative distance of the peripheral vehicle 120 to indicate the relative distance from the center point of the peripheral vehicle 120 to the vehicle 110.

In an embodiment, the vehicle 120 may determine a relative position from the center point of the peripheral vehicle 120 to an environmental sensor installed in the vehicle 120 and determine the size of the peripheral vehicle 120.

In one embodiment, when a distance between the peripheral vehicles 120 is too close, one peripheral vehicle 120 may cover a part of another peripheral vehicle 120, and the vehicle 110 does not acquire the point cloud data for the covered part of the corresponding peripheral vehicles 120 through the Lidar sensor, and thus, an error in the calculation of the center point may occur.

In this case, the vehicle 110 recognizes the covered peripheral vehicles 120 using an object bounding box through a camera sensor, but may determine the center point of the corresponding peripheral vehicle 120 only when a distance between the virtual straight line connecting the starting point and the end point of the middle point of the point cloud data for the peripheral vehicle 120 acquired through the Lidar sensor is larger than a threshold.

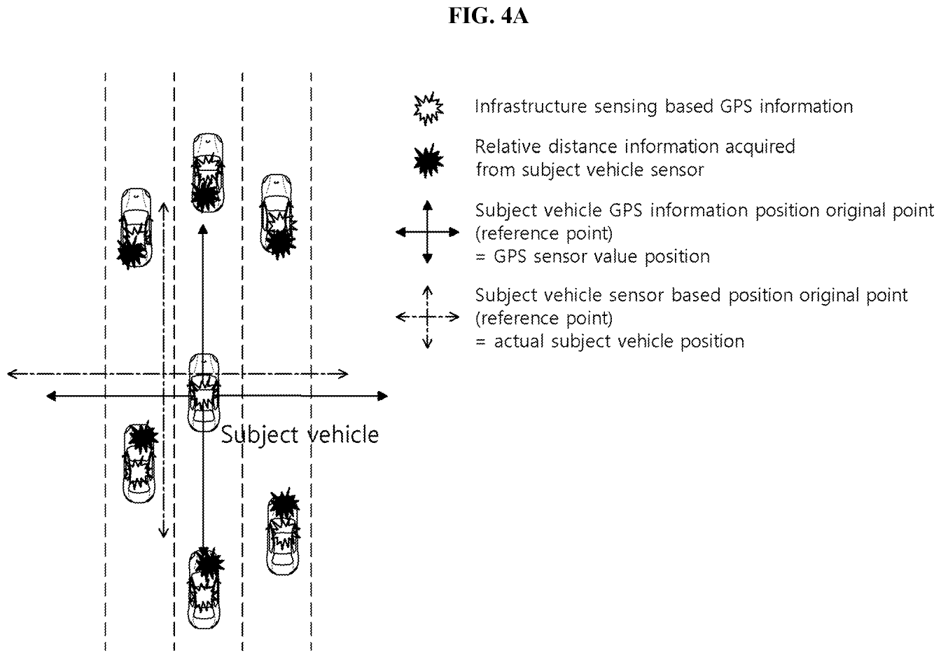

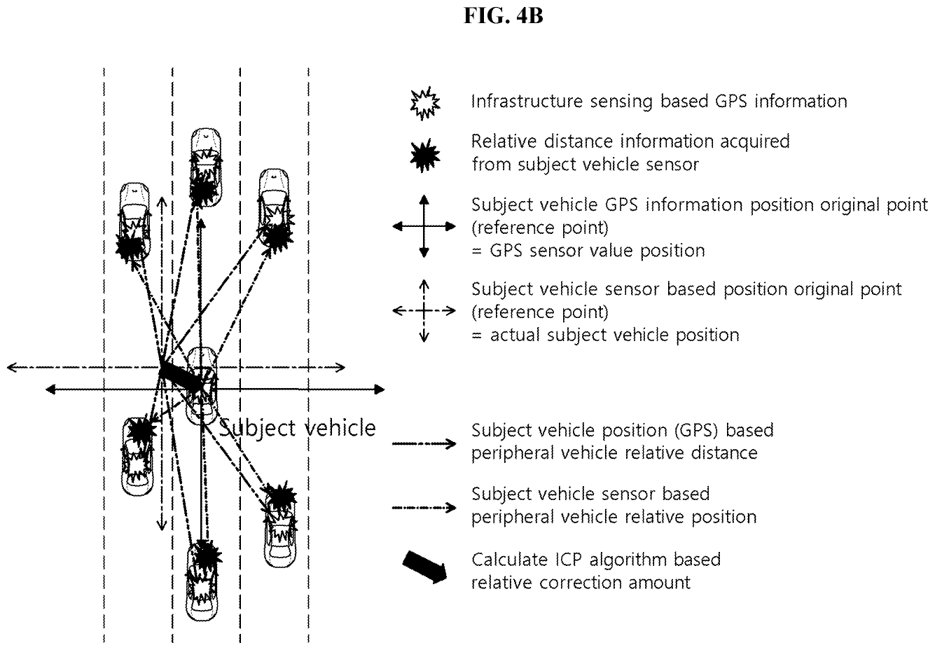

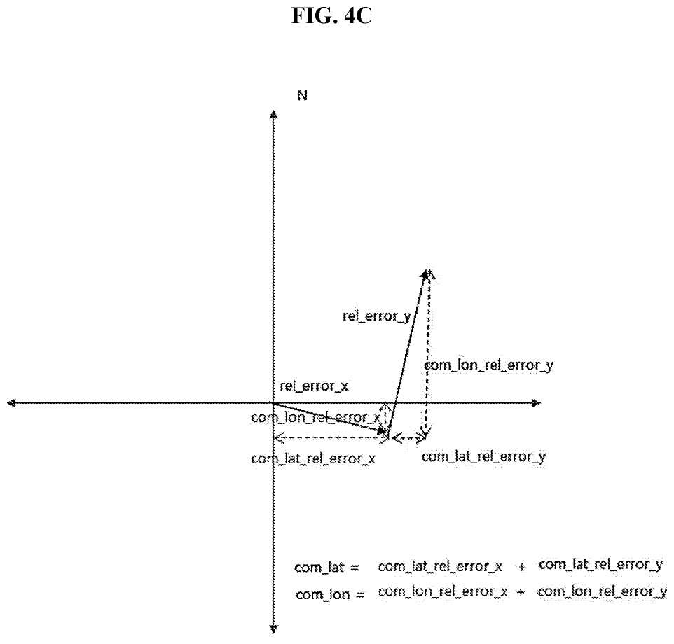

FIGS. 4A to 4C are diagrams illustrating examples of improving positioning of a vehicle based on infrastructure sensing information according to an embodiment of the present disclosure.

Referring to FIGS. 4A to 4C, the vehicle 110 may calculate the first relative distance of the peripheral vehicle 120 using an environmental sensor mounted on the vehicle 110. In this case, based on an actual position of the vehicle 110, the first relative distance of the peripheral vehicle 120 may be calculated from the actual position of the vehicle 110.

In addition, the vehicle 110 may calculate the second relative distance of the peripheral vehicle 120 from the absolute position of the peripheral vehicle 120 received from the infrastructure device 130 based on the absolute position of the vehicle 110.

In one embodiment, the absolute position of the peripheral vehicle 120 received from the infrastructure device 130 may be referred to as “infrastructure sensing information” or a term having a technical meaning equivalent thereto.

In one embodiment, the vehicle 110 may calculate a relative positioning amount of the vehicle 110 by performing an iterative closest point (ICP) algorithm using the first relative distance and the second relative distance.

Thereafter, the vehicle 110 may convert the relative positioning correction amount to an absolute positioning correction amount for the vehicle 110, and correct the absolute position of the vehicle 110 using the absolute positioning correction amount.

In one embodiment, referring to FIG. 4C, the first relative distance and the second relative distance include distance information and direction information, and accordingly, the vehicle 110 may calculate difference information (rel_error_x, rel_error_y) between the first relative distance and the second relative distance.

Thereafter, the vehicle 110 may extract a latitude component and a longitude component from the difference information (rel_error_x) along the first direction, and extract a latitude component and a longitude component from the difference information (rel_error_y) along the second direction.

Also, the vehicle 110 may generate final latitude correction information (com_lat) by adding the latitude component (com_lat_rel_error_x) of rel_error_x and the latitude component (com_lat_rel_error_y) of rel_error_y.

Also, the vehicle 110 may generate final longitude correction information (com_lon) by adding the longitude component (com_lon_rel_error_x) of rel_error_x and the longitude component (com_lon_rel_error_y) of rel_error_y.

Also, the vehicle 110 may generate an absolute positioning correction amount including the latitude correction information (com_lat) and the longitude correction information (com_lon), and correct the absolute position of the vehicle 110 using the absolute positioning correction amount.

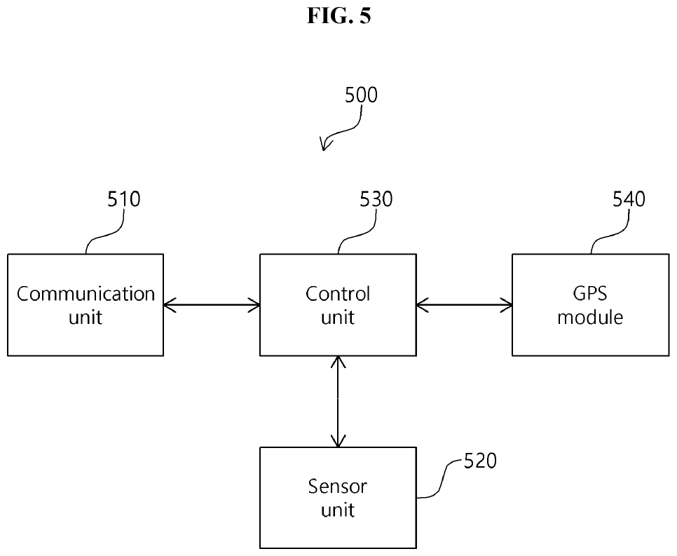

FIG. 5 is a diagram illustrating a functional configuration of an apparatus for improving positioning of the vehicle 110 based on infrastructure sensing information according to an embodiment of the present disclosure. In one embodiment, a positioning improvement apparatus 500 may be included in the vehicle 110.

Referring to FIG. 5, the positioning improvement apparatus 500 may include a communication unit 510, a sensor unit 520, a control unit 530, and a GPS module 540.

The communication unit 510 may receive an absolute position of the peripheral vehicle 120 located within a certain distance to the vehicle 110 from the infrastructure device 130.

In one embodiment, the communication unit 510 may include at least one of a wired communication module and a wireless communication module. All or a part of the communication unit 510 may be referred to as a ‘transmitter’, ‘receiver, or ‘transceiver’.

The sensor unit 520 may detect the peripheral vehicle 120. In an embodiment, the sensor unit 520 may include an environmental sensor.

The control unit 530 may determine the first relative distance of the peripheral vehicle 120 detected by the sensor unit 520, and perform positioning correction for the absolute position of the vehicle 110 based on the absolute position of the peripheral vehicle 120 and the first relative distance of the peripheral vehicle 120.

In one embodiment, the control unit 530 may include at least one processor or microprocessor, or a part of the processor. Further, the control unit 530 may be referred to as a communication processor (CP). The control unit 530 may control the operation of the positioning improvement apparatus 500 according to various embodiments of the present disclosure.

The GPS module 540 may acquire the absolute position of the vehicle 110. For example, the absolute position may include a GPS coordinate.

In one embodiment, the GPS module 540 may receive a GPS signal through a satellite and process data to acquire coordinate information. The coordinate information acquired through the GPS module 540 may include a longitude value and a latitude value, and may further include altitude information as implemented.

The GPS module 540 used in the positioning improvement apparatus 500 according to the embodiment of the present disclosure is a low-cost product, and thus, the acquired coordinate information may have an error. Of course, even if there are some errors, it is possible to sufficiently check which road the vehicle is located on and the like, but in order to accurately determine which lane the vehicle is driving on, it is necessary to identify more precise positioning.

Referring to FIG. 5, the positioning improvement apparatus 500 may include the communication unit 510, the sensor unit 520, the control unit 530, and the GPS module 540. In various embodiments of the present disclosure, since the components described in FIG. 5 are not required, the positioning improvement apparatus 500 may be implemented with more components or less components than the components described in FIG. 5.

The above description is just illustrative of the technical idea of the present disclosure, and various changes and modifications can be made within the scope without departing from the essential characteristics of the present disclosure.

Various embodiments disclosed herein may be performed regardless of the order, and may be performed simultaneously or separately.

In one embodiment, at least one step may be omitted or added in each of the drawings described herein, and may be performed in reverse order, and may be performed simultaneously.

Therefore, the exemplary embodiments of the present disclosure are provided for illustrative purposes only but not intended to limit the technical concept of the present disclosure. The scope of the technical concept of the present disclosure is not limited thereto.

The protective scope of the present disclosure should be construed based on the following claims, and all the techniques in the equivalent scope thereof should be construed as falling within the scope of the present disclosure.

What is claimed is:

1. A method for improving positioning of vehicles based on infrastructure sensing information, the method comprising steps of:
(a) receiving an absolute position of a peripheral vehicle located within a certain distance to a vehicle from an infrastructure device;
(b) determining a first relative distance of the peripheral vehicle through an environmental sensor of the vehicle; and
(c) performing positioning correction for the absolute position of the vehicle based on an absolute position of the peripheral vehicle and a first relative distance of the peripheral vehicle.

2. The method of claim 1, wherein the absolute position of the peripheral vehicle is determined from an absolute position of the infrastructure device and a second relative distance of the peripheral vehicle calculated by the infrastructure device.

3. The method of claim 1, wherein step (c) comprises steps of:
converting the absolute position of the peripheral vehicle to the second relative distance of the peripheral vehicle based on the absolute position of the vehicle; and
performing positioning correction of the absolute position of the vehicle based on the first relative distance of the peripheral vehicle and the second relative distance of the peripheral vehicle.

4. The method of claim 3, wherein step (c) comprises steps of:
calculating a relative positioning correction amount for the vehicle based on the first relative distance of the peripheral vehicle and the second relative distance of the peripheral vehicle; and
converting the relative positioning correction amount for the vehicle to an absolute positioning correction amount for the vehicle.

5. The method of claim 4, wherein step (c) comprises a step of correcting the absolute position of the vehicle using the absolute positioning correction amount for the vehicle.

6. An apparatus for improving positioning of vehicles based on infrastructure sensing information, the apparatus comprising:
a communication unit for receiving an absolute position of a peripheral vehicle located within a certain distance to a vehicle from an infrastructure device; and
a control unit for determining a first relative distance of the peripheral vehicle through an environmental sensor of the vehicle and performing positioning correction for the absolute position of the vehicle based on an absolute position of the peripheral vehicle and a first relative distance of the peripheral vehicle.

7. The apparatus of claim 6, wherein the absolute position of the peripheral vehicle is determined from an absolute position of the infrastructure device by the infrastructure device and a second relative distance of the peripheral vehicle calculated by the infrastructure device.

8. The apparatus of claim 6, wherein the control unit converts the absolute position of the peripheral vehicle to the second relative distance of the peripheral vehicle based on the absolute position of the vehicle, and
performs positioning correction of the absolute position of the vehicle based on the first relative distance of the peripheral vehicle and the second relative distance of the peripheral vehicle.

9. The apparatus of claim 8, wherein the control unit calculates a relative positioning correction amount for the vehicle based on the first relative distance of the peripheral vehicle and the second relative distance of the peripheral vehicle, and
converts the relative positioning correction amount for the vehicle to an absolute positioning correction amount for the vehicle.

10. The apparatus of claim 9, wherein the control unit corrects the absolute position of the vehicle using the absolute positioning correction amount for the vehicle.
